(19) United States
(12) Patent Application Publication
(10) Pub. No.: US 2003/0135764 A1
(43) Pub. Date: Jul. 17, 2003

(54) Authentication system and apparatus having fingerprint verification capabilities thereof

(76) Inventor: Kun-Shan Lu, Taipei (TW)

Correspondence Address: J.C. Patents, Inc., 4 Venture, Suite 250, Irvine, CA, 92618, US

(21) Appl. No.: 10/047,747

(22) Filed: Jan. 14, 2002

(51) Int. Cl. H04L 9/32

(52) U.S. Cl. 713/202

(57) ABSTRACT

An authentication system is disclosed. The authentication system comprises an artificial intelligent device is connected to a network server via either wired or wireless communication network system. The authentication system comprises a processor for analyzing said fingerprint digitized data, a comparator matches the fingerprint data to historical fingerprint data maintained in a database to verify and to establish the authenticity of the fingerprint and an access mechanism for allowing or denying an authorized user to access the secured site.

### BACKGROUND OF THE INVENTION

1. Field of Invention

The present invention relates generally to an authentication system. More particularly, the present invention relates to a fingerprint authentication system for accessing secured sites and apparatus having fingerprint verification capabilities thereof

2. Description of Related Art

It has become increasingly popular for users to remotely access public and private network for public use and business use, by using an artificial intelligent device through wired or wireless communication network. The information stored in the private network for business or personal use may include, but is not limited to, bank accounts, credit card numbers, addresses, commercial trade secrets, criminal records in characters, graphic images, moving pictures, sound, and animation. The artificial intelligent device may be provided with an Internet-based document management system and methods that allows user to access to services supported by a common Internet-based database, including storage of data, data sharing and document distribution. Further, the artificial intelligent device may be provided an Internet-based document management system and methods that allows the user to selectively filter electronic documents during storage to and retrieval from, an Internet-based storage site. Furthermore, the artificial intelligent device may be provided an Internet-based document management system and methods that allows users to collaboratively store, retrieve, modify and then return an electronic document to an Internet-based storage site. It is also further desirable to provide the artificial intelligent device a system for the construction and validation of access keys for use in an Internet-based document management system, where the access keys are not derived from user or resource information and can be used to control access to the services offered by the document management system. Still, further, the artificial intelligent device may be provided an Internet-based document management system and methods that enable the transaction logging and accounting functions needed for multi-user collaborative electronic document manipulation, for example, so that revisions to a document may be tracked. It also would be desirable to provide the artificial intelligent device an Internet-based document management system and methods that enable tracking of transactions performed on a document for billing purposes, and which provide needed access-control protocols.

Therefore it is highly important to protect access to aforementioned services to any unauthorized users. Conventionally, a personal computer is coupled with an authentication software system that typically requires logging in identification name and password, which is verified to allow the authorized user to access the services. However, one problem is that the user may forget the password. Even in more serious situation, the password may be stolen without the knowledge of the user. Further, the procedure of keying in the identification name and the password is a time consuming process.

### SUMMARY OF THE INVENTION

The present inventors observed that every fingerprint typically comprises a series of spaced apart curved ridges resembling a topographical map which is unique for every human. The data representative of the topographical map offers a conveniently compressed form of identifier that retains the uniqueness of a fingerprint. The present inventors realized the uniqueness of human fingerprint in identification, and proposed to apply this for secure accessing of personal computers and other secured sites within the personal computer such as personal files and internet-based management systems, instead of conventional authentication system which requires keying in identification name and password, thus, problems associated with said conventional authentication system can be effectively resolved. The present inventors also considered the economical aspect for such authentication system. Accordingly, the present inventors designed a multifunctional fingerprint verifying artificial intelligent device for both authentication and camera functions.

Accordingly, in the light of the foregoing, the present invention provides a new artificial intelligent device and a new authentication system, which system is simple, accurate and fast in processing the authentication.

In accordance with one object of the invention, a new multi-functional artificial intelligent device, which device is at least capable of functioning both receiving and/or transmitting optical image signals with or without sound signals, and means of converting the optical image into digital data.

In accordance with another object of the invention, a new authentication system, which system eliminates the inconvenience of keying in identification name and password. Therefore problems associated with conventional authentication methods can be effectively resolved.

In accordance with yet another object of the invention, a new authentication system using an artificial intelligent device, which system provides a reliable, fast, accurate and ease-to-use fingerprint authentication to access secured environment.

In accordance with above objects of the present invention, a new artificial intelligent device comprising multiple functions having at least a scanning function for scanning the fingerprints and means of converting said fingerprints into digital data, which can be processed fast with quick enrollment of fingerprints within a short time, and a new authentication system by way of verifying the real time fingerprint digital identifier data with the fingerprint digital identifier data previously stored in a database and which system comprises means of granting or denying access to a secured environment according to the result of the fingerprint verification.

In accordance with one aspect of the invention, a new authentication system for allowing an authorized user for secure access to an internet-based management system. For doing so, a first fingerprint digital identifier is generated by using the artificial intelligent device, which is unique to the internet-based management system, by using particular attributes of the artificial intelligent device having means for generating the first fingerprint digital identifier. The first fingerprint digital identifier is stored as a personal computer file which is being secured to the authentication system. A second fingerprint digital identifier is generated by using the artificial intelligent device upon an attempt by a user to access the internet-based management system, using the same algorithm which created the first fingerprint digital identifier, but using the attributes of the artificial intelligent device attempting to access the internet-based management system. The first and second fingerprint digital identifiers are then compared, and when the first and second digital identifiers are identical, the user attempting to access the internet-based management system is recognized as the authorized user, and the user is allowed to access the internet-based management system. On the contrary, if the first and second fingerprint digital identifier are not identical, the user attempting to access the internet-based management system is not recognized as an authorized user, and the user is denied to access the internet-based management system.

In accordance with another aspect of the invention, a new authentication system for allowing an authorized user for secure access to a personal computer. For doing so, a first fingerprint digital identifier is generated by using the artificial intelligent device, which is unique to the personal computer, by using particular attributes of the personal computer having means for generating the first fingerprint digital identifier. The first fingerprint digital identifier is stored as a personal computer file which is being secured to the personal computer. A second fingerprint digital identifier is generated upon an attempt by a user to access the personal computer by using the artificial intelligent device, using the same algorithm which created the first fingerprint digital identifier, but using the attributes of the personal computer attempting to access the personal computer. The first and second fingerprint digital identifiers are then compared, and when the first and second digital identifiers are identical, the user attempting to access the personal computer is recognized as the authorized user, and the user is allowed to access the personal computer. On the contrary, if the first and second fingerprint digital identifier are not identical, the user attempting to access the personal computer is not recognized as an authorized user, and the user is denied to access the personal computer

In accordance with yet another aspect of the invention, a new authentication system to securely lock a computer file with a target computer system is provided. The method provides for the prevention of access to the computer files by unauthorized computer systems other than the target computer system. For doing so, a first fingerprint digital identifier is generated by using the artificial intelligent device, which is unique to the target computer system, by using particular attributes of the target computing system having means for generating the first fingerprint digital identifier. The first fingerprint digital identifier is stored as a personal computer file which is being secured to the target computer system. A second fingerprint digital identifier is generated by using the artificial intelligent device upon an attempt by a computer system other than the target computer system, to access the computer file, using the same algorithm which created the first fingerprint digital identifier, but using the attributes of the computer system attempting to access the computer file. The first and second fingerprint digital identifiers are then compared, and when the first and second digital identifiers are identical, the computer system attempting to access the computer file is recognized as the authorized user, and the computer system is allowed to access the computer file. On the contrary, if the first and second fingerprint digital identifier are not identical, the computer system attempting to access the computer file is not recognized as an authorized user, and the computer system is denied to access the computer file.

In accordance with one aspect of the present invention, the artificial intelligent device is a personal computer camera having dual functionality. The personal computer camera comprises a camera housing. The camera housing comprises a camera window disposed facing a horizontal plane, a scanning window disposed on the top of the camera housing. A camera device is disposed within the camera housing. The camera device comprises at least a prism and a sensor. The camera device is pivotally mounted and can be rotated along a fixed horizontal axis through a knob provided on the side of the camera housing for capturing the image through the camera window or the scanning window

In accordance with another aspect of the present invention, the artificial intelligent device is a scanning device. The scanning device comprising at least a camera device, a scanning window for scanning fingerprint image, and means of converting said fingerprint image into a fingerprint digital identifier data.

In accordance with another aspect of the present invention, the artificial intelligent device is a projector. The projector comprising at least a camera device, and at least a scanning window for scanning fingerprint image, and means of converting said fingerprint image into a fingerprint digital identifier data and means of verifying said fingerprint identifier data.

In accordance with another aspect of the present invention, the artificial intelligent device is a monitor, such as a television set or a monitor of a computer device. Said monitor comprising at least a camera device, a scanning window for scanning fingerprint image, and means of converting said fingerprint image into a fingerprint digital identifier data and means of verifying said fingerprint identifier data.

In accordance with another aspect of the present invention, the authentication system comprises a personal computer device such as but not limited to a desk-top computer system, a notebook computer system, a packet computer system, and the like. Said personal computer device comprising at least a camera device, a scanning window for scanning fingerprint image, and means of converting said fingerprint image into a fingerprint digital identifier data, means of verifying the fingerprint digital identifier data and means for allowing or denying access to a secured site.

In accordance with another aspect of the present invention, the authentication system comprises a portable handheld device such as but not limited to a cellular phone, a PDA and the like. Said portable handheld device comprising at least a camera device, a scanning window for scanning fingerprint image, and means of converting said fingerprint image into a fingerprint digital identifier data, means of verifying the fingerprint digital identifier data and means for allowing or denying access to a secured site.

In accordance with one aspect of the present invention, the camera device comprises at least a sensor, a stationary lens and a non-stationary lens, wherein the stationary lens is disposed in between the sensor and the non-stationary lens. The non-stationary lens can be moved with respect to the stationary lens for adjusting the focal length in order to capture the image of the object on the stationary screen 400, which image is converted into digital identifier data.

Other objects and advantages of the present invention will become readily apparent to those skilled in this art from the following detailed description. Therefore, it is understood that the foregoing general description and the following detailed description are exemplary, but are not restrictive, of the present invention.

### BRIEF DESCRIPTION OF THE DRAWING

FIG. 1 is a schematic drawing showing a typical human fingerprint;

FIG. 2 is a schematic flow chart showing an authentication system in accordance with a preferred embodiment of the present invention;

FIG. 3 is a schematic process flow chart showing detailed process steps in accordance with a preferred embodiment of the present invention;

FIGS. 4A-4B is a schematic showing a conventional camera device;

FIG. 5 is a camera device in accordance with a preferred embodiment of the present invention;

FIG. 6 is a schematic front view showing a personal computer camera in accordance with a preferred embodiment of the present invention;

FIG. 7 is a schematic side view showing a personal computer camera in accordance with a preferred embodiment of the present invention;

FIG. 7A is a schematic cross sectional side view taken along line I-I showing personal computer camera showing capturing image through the camera window configuration in accordance with a preferred embodiment of the present invention;

FIG. 7B is a schematic cross sectional side view taken along line I-I showing personal computer camera showing capturing image through the scanning window configuration in accordance with a preferred embodiment of the present invention;

FIG. 8 is a schematic showing a scanning device having at least a window for capturing an optical image in accordance with a preferred embodiment of the present invention;

FIG. 9 is a schematic showing a projector device having at least a window for capturing an optical image in accordance with a preferred embodiment of the present invention;

FIG. 10 is a schematic front view showing a monitor having at least a window for capturing an optical image in accordance with a preferred embodiment of the present invention;

FIG. 11 is a schematic showing a personal computer having at least a window for capturing an optical image in accordance with a preferred embodiment of the present invention;

FIG. 12 is a schematic front view showing a cellular phone having at least a window for capturing an optical image in accordance with a preferred embodiment of the present invention;

FIG. 13 is a schematic front view showing a PDA having at least a window for capturing an optical image in accordance with a preferred embodiment of the present invention; and

FIG. 14 is a schematic showing a camera device in accordance with a preferred embodiment of the present invention.

### DETAILED DESCRIPTION OF THE PREFERRED EMBODIMENTS

Reference will be made in detail to the present preferred embodiments of the invention, examples of which are illustrated in the accompanying drawings. Wherever possible, the same reference numbers are used in the drawings and the description to refer to the same or like parts.

It is to be understood that the foregoing general description and the following detailed description are exemplary, and are intended to provide further explanation of the invention as claimed.

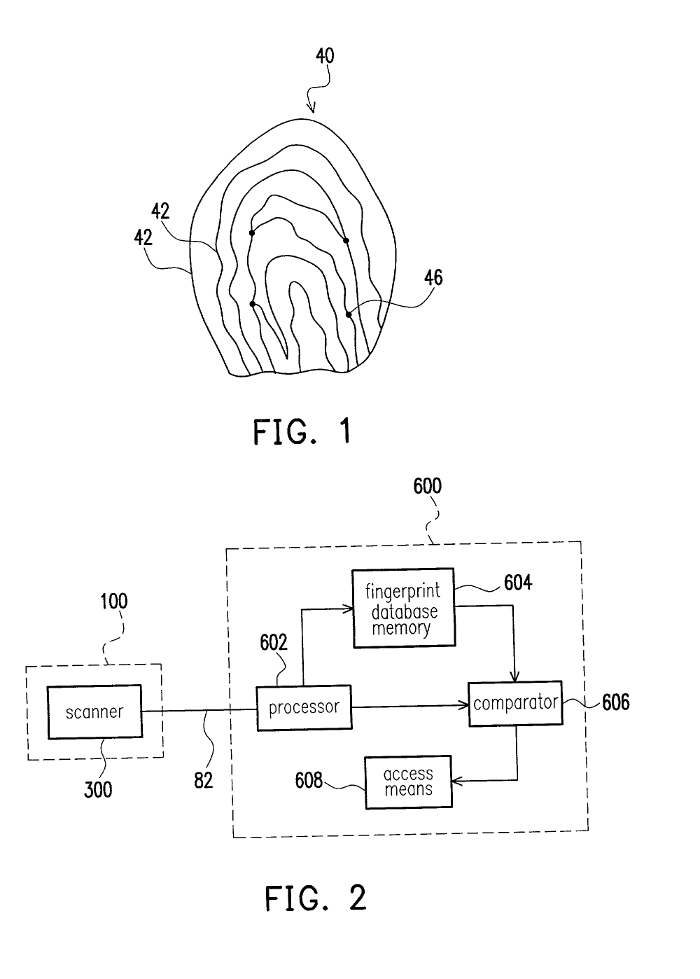

Referring to FIG. 1, a portion of a human fingerprint 40 is shown with a sizeable number of peripheral ridges 42. A number of the ridges that are clustered near the center of the fingerprint exhibit irregularities in the form of ridge terminations 44 and ridge bifurcations 46 which is unique for every humans. Such irregularities are conveniently detectable by fingerprint scanning machines which are converted into digital identifier for fingerprint comparison.

Referring to FIG. 2, a fingerprint authentication system 80 according to one preferred embodiment of the present invention includes an artificial intelligent device 100 comprising at least a scanning window 300, for selectively allowing user to place a finger for fingerprint imaging. The artificial intelligent device 100 is coupled to a network server 600 through wired or wireless communication network system 82.

Still referring to FIG. 2, the scanning window 300 includes a fingerprint sensor for generating real time fingerprint digital identifier of an applied fingerprint and stored as a personal file in the personal computer 600. The fingerprint sensor, according to one preferred embodiment of the present invention any sensor suitable for capturing the fingerprint image and for converting said fingerprint into a digital data. The network server 600 comprises a processor 602. The processor 602 receives the scanned fingerprint digital identifier data from the scanning window 300 through wired or wireless communication network 82 and in response to this signal, the real time discrete topographical minutia points of the fingerprint are located. Processing includes, for example, extracting minutia points representing individual endings of fingerprint ridges and bifurcations between ridges, then identifying at least one real time physical relationship between the real time minutia points. The processor 62 then converts the data representing such physical relationships into a real time fingerprint digital identifier data that may be used for comparison to other stored fingerprint digital identifier data stored in a fingerprint database memory 604 of the network server 600. The processor 602 is coupled to the fingerprint database memory 604 to maintain previously stored fingerprint digital identifier data for comparison of the real time fingerprint digital identifier data to the same previously detected fingerprint digital identifier data that is stored in the fingerprint database memory 604. The processor 602 comprises means of statistically analyzing the real time fingerprint digital identifier data as an individual sample with same previously detected fingerprint digital identifier data that is stored in the fingerprint database memory 604. The statistical criteria comprising values of physical relationships between predetermined minutia, or calculated standard deviations between minutia of the fingerprint image. The network server 600 further comprises a comparator 606 disposed at a second output of the processor 602 for receiving the processed real time fingerprint digital identifier data and matching against fingerprint digital identifier data stored in the fingerprint database memory 604. The comparator generates a verification signal for transmission to an access means 608 to admit or deny entry to the secured sites.

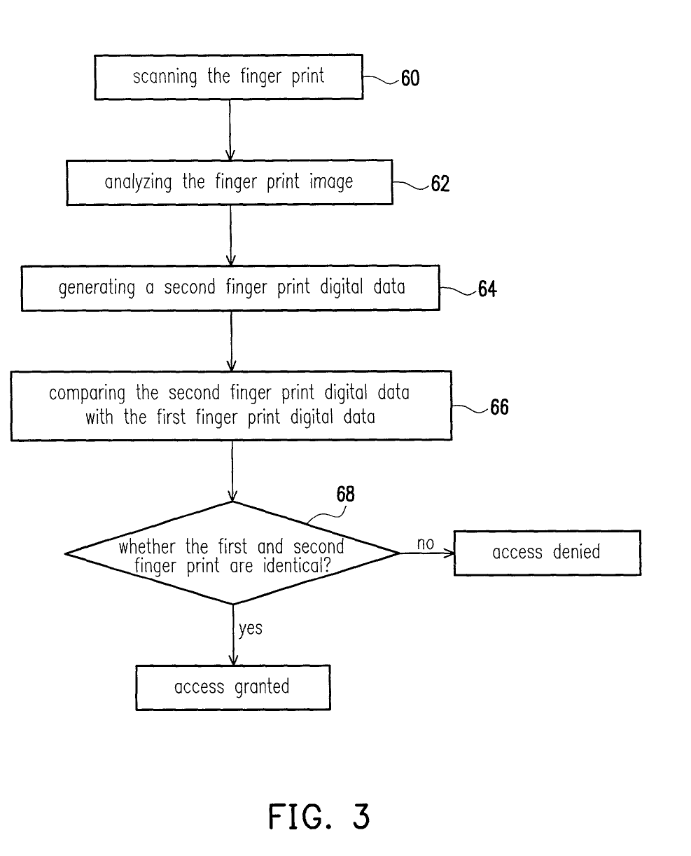

Operation of the authentication system 80 of the present invention for accessing a network server 600 or various other restricted data files, such as, within the network server 600 or an internet-based management system provided in the network server 600, proceeds according to the method of the present invention as shown in FIG. 3. In step 60, a user desiring access to the network server 600 places his finger onto the scanning window 300 of the artificial intelligent device 100 of the present invention, for scanning a real time optical image of his fingerprint.

In step 62, the scanned fingerprint image comprises digitized data is transmitted through the wired or wireless communication network system 82 and this data is captured and analyzed by the processor 602 of the network server 600.

In step 64, based on the analysis in step 62, the processor 602 then identifies and measures at least one real time physical relationship between the real time minutia points. Typically, this involves extracting minutia representing individual endings of fingerprint ridges or bifurcations of fingerprint ridges and assigning values to respective relationships between minutia. The values are used to generate a real time fingerprint digital data for the scanned fingerprint.

In step 66, once the real time fingerprint digital data is generated, it is compared with the previously detected fingerprint digital data according to statistical criteria.

In step 68, with the statistical criteria established, the comparator 606 compares the real time fingerprint digital identifier data to determine whether the real time fingerprint digital identifier data has physical relationship data no greater than the established statistical criteria to establish an initial match. If no such match is established, then an access denied signal is sent to the access means 608, denying the user to access the secured site. And, if the match is established, an access signal is sent to the access means 608, allowing the user to access the secured site.

In accordance with another aspect of the invention, a new authentication system for allowing an authorized user for secure access to a personal computer. For doing so, a first fingerprint digital identifier is generated, which is unique to the personal computer. The first fingerprint digital identifier is stored as a personal computer file which is being secured to the personal computer. A second fingerprint digital identifier is generated upon an attempt by a user to access the personal computer by following steps 60 through 66, using the same algorithm which created the first fingerprint digital identifier. The first and second fingerprint digital identifiers are then compared as described in steps 68, and when the first and second digital identifiers are identical, the user attempting to access the personal computer is recognized as the authorized user, and the user is allowed to access the personal computer. On the contrary, if the first and second fingerprint digital identifier are not identical, the user attempting to access the personal computer is not recognized as an authorized user, and the user is denied to access the personal computer.

In accordance with one aspect of the invention, a new authentication system to securely lock a computer file with a target computer system is provided. The method provides for the prevention of access to the computer files by unauthorized computer systems other than the target computer system. For doing so, a first fingerprint digital identifier is generated, which is unique to the target computer system, by using particular attributes of the target computing system having means for generating the first fingerprint digital identifier. The first fingerprint digital identifier is stored as a personal computer file which is being secured to the target computer system. A second fingerprint digital identifier is generated upon an attempt by a computer system other than the target computer system, to access the computer file by following steps 60 through 66, using the same algorithm which created the first fingerprint digital identifier. The first and second fingerprint digital identifiers are then compared as described in step 68, and when the first and second digital identifiers are identical, the computer system attempting to access the computer file is recognized as the authorized user, and the computer system is allowed to access the computer file. On the contrary, if the first and second fingerprint digital identifier are not identical, the computer system attempting to access the personal computer file is not recognized as an authorized user, and the computer system is denied to access the personal computer file.

In accordance with another aspect of the invention, a new authentication system for allowing an authorized user for secure access to an internet-based management system. For doing so, a first fingerprint digital identifier is generated, which is unique to the internet-based management system, by using particular attributes of the personal computer having means for generating the first fingerprint digital identifier. The first fingerprint digital identifier is stored as a personal computer file which is being secured to the personal computer. A second fingerprint digital identifier is generated upon an attempt by a user to access the internet-based management system, using the same algorithm which created the first fingerprint digital identifier by following steps 60 through 66. The first and second fingerprint digital identifiers are then compared as described in step 68, and when the first and second digital identifiers are identical, the user attempting to access the internet-based management system is recognized as the authorized user, and the user is allowed to access the internet-based management system. On the contrary, if the first and second fingerprint digital identifier are not identical, the user attempting to access the internet-based management system is not recognized as an authorized user, and the user is denied to access the internet-based management system.

In accordance with one aspect of the present invention, the artificial intelligent device 100 is a personal computer camera having multiple functions and the network server 600 is a personal computer. The artificial intelligent device comprising at least a scanning window and a camera window. A camera device disposed within the artificial intelligent device is pivotally mounted and can be rotated along a fixed horizontal axis through a knob which is disposed on the side of the camera housing for selecting to capture images through the camera window or the scanning window. Accordingly, a single sensor can be used for camera and fingerprint scanning functionalities. The personal computer camera can be coupled to the personal computer, wherein the personal computer comprises means of authentication. Thus, the present invention provides an improved electronic authentication device without any additional specialized hardware, offering a highly inexpensive alternative to relatively costly devices traditionally used for scanning the fingerprint devices.

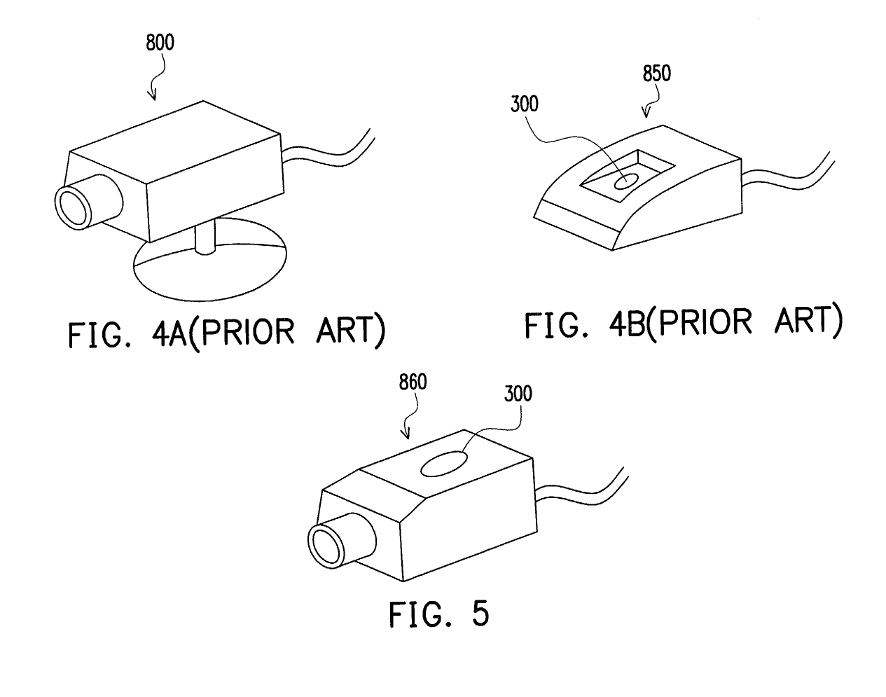

Referring FIGS. 4A and 4B is a schematic showing a conventional camera device 800. As is well known in the art that a camera device is available without any built-in scanner device, although a scanner device 850 may be externally connected to the camera device 800 for security function. The present inventor developed a new authentication device 860 comprising at least a camera device and at least a built-in scanner device having a scanning window 300 for scanning images as shown in FIG. 5. The scanning window 300 is for scanning fingerprint image. The authentication system comprises means of converting said fingerprint image into a fingerprint digital identifier data. The authentication device 860 can be coupled to a network server through a wired or wireless communication network system, wherein said network server comprises means of verifying said fingerprint identifier data and means for allowing or denying access to secured sites according to the result of the verification of said fingerprint identifier data.

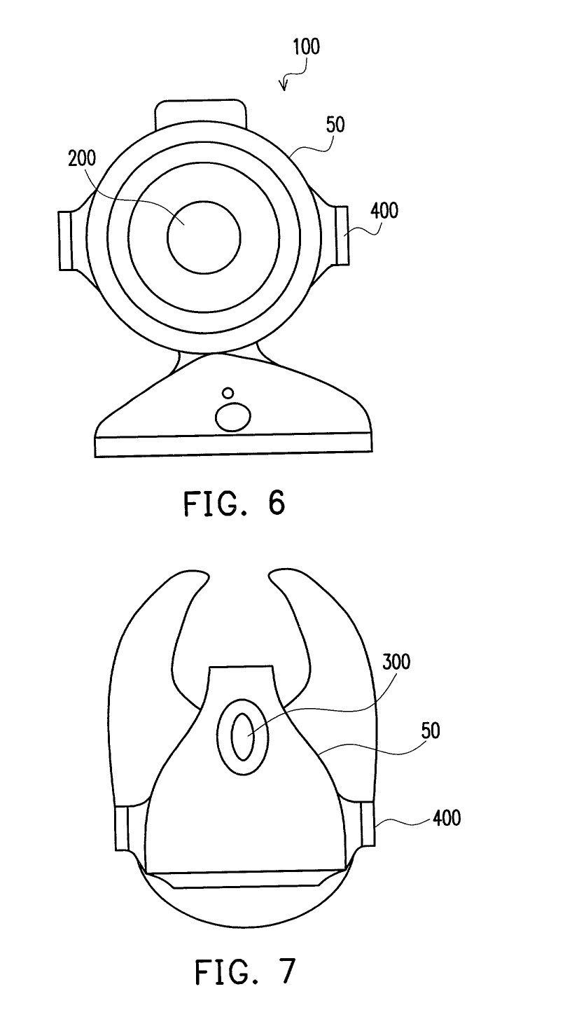

Referring to FIG. 6, the figure shows a schematic front view of a personal computer camera 100 according to a preferred embodiment of the present invention. The personal computer camera comprises a camera housing 50. The camera housing 50 comprises a camera window 200 disposed on a frontal plane of the personal computer camera 100 and a knob 400 disposed on the side of the camera housing 50.

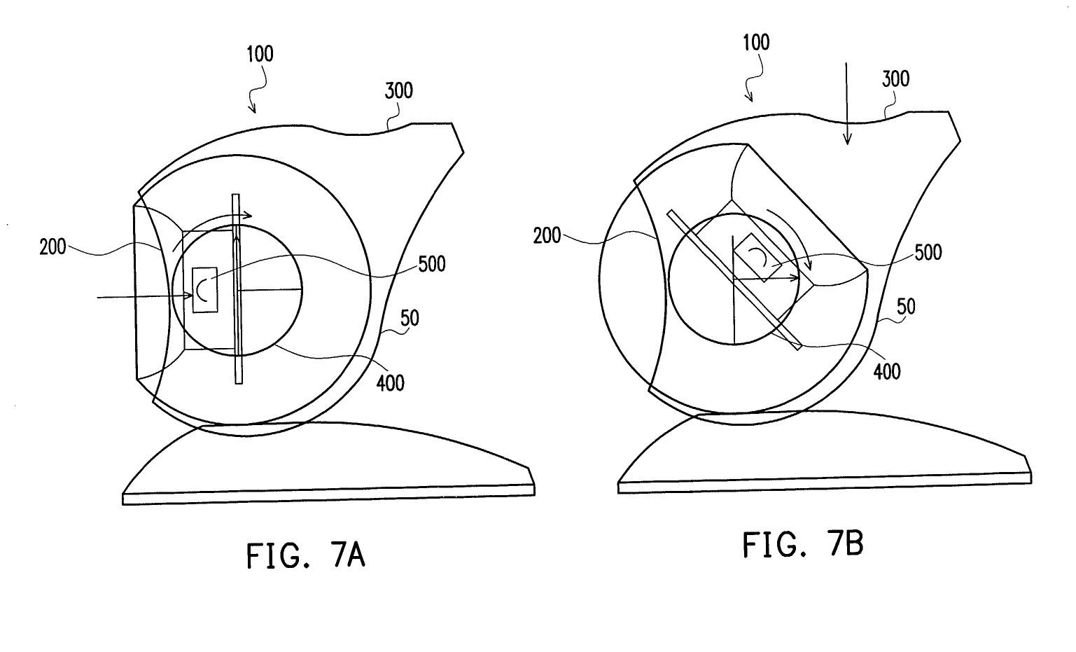

Referring to FIG. 7, the figure shows a schematic top view of a personal video camera 100 according to a preferred embodiment of the present invention. The camera housing 50 further comprises a scanning window 300 is disposed on the top of the camera housing 50 is shown.

Referring to FIGS. 7A-7B, the figure shows a schematic cross sectional view along I-I of a personal computer camera 100 according to a preferred embodiment of the present invention. An electronic camera 500 is disposed within the camera housing 50 for converting an optical image into an electronic image. The electronic camera 500 comprises at least a prism and a sensor (not shown), wherein the electronic camera 500 is pivotally mounted and can be rotated along a horizontal axis through the knob 400 for selecting to capture an optical image through either the camera window 200 as shown in FIG. 6A or through the scanning window 300 as shown in FIG. 6B. The personal computer camera 100 can be coupled to a network server through a wired or wireless communication network system, wherein said network server comprises means of verifying said fingerprint identifier data and means for allowing or denying access to secured sites according to the result of the verification of said fingerprint identifier data.

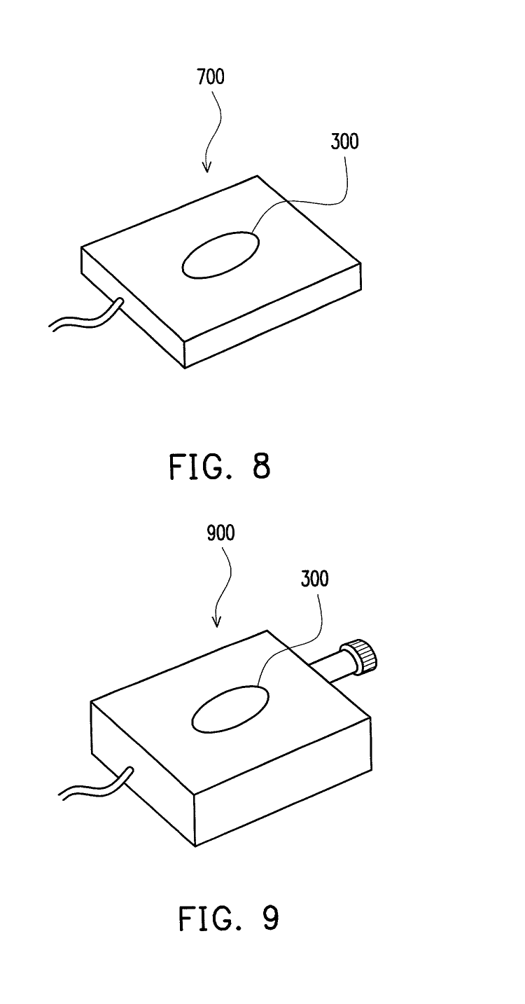

Referring to FIG. 8, is a schematic showing a scanning device 700 in accordance with a preferred embodiment of the present invention. The scanning device 700 comprises at least a camera device (not shown), a scanning window 300 for scanning fingerprint image, and means of converting said fingerprint image into a fingerprint digital identifier data. The scanning device 700 can be coupled to a network server through a wired or wireless communication network system, wherein said network server comprises means of verifying said fingerprint identifier data and means for allowing or denying access to secured sites according to the result of the verification of said fingerprint identifier data.

Referring FIG. 9 is a schematic showing a projector device 900 in accordance with a preferred embodiment of the present invention. The projector device 900 comprises at least a camera device (not shown), a scanning window 300 for scanning fingerprint image, and means of converting said fingerprint image into a fingerprint digital identifier data. The projector device 900 can be coupled to a network server through a wired or wireless communication network system, wherein said network server comprises means of verifying said fingerprint identifier data and means for allowing or denying access to secured sites according to the result of the verification of said fingerprint identifier data.

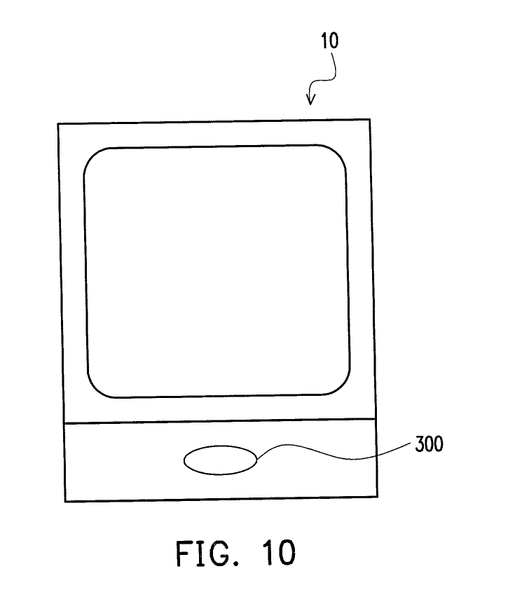

Referring to FIG. 10, is a schematic front view showing a monitor 10 in accordance with a preferred embodiment of the present invention. The monitor 10 comprises at least a camera device (not shown), a scanning window 300 for scanning fingerprint image and means of converting said fingerprint image into a fingerprint digital identifier data. The monitor 10 can be coupled to a network server through a wired or wireless communication network system, wherein said network server comprises means of verifying said fingerprint identifier data and means for allowing or denying access to secured sites according to the result of the verification of said fingerprint identifier data.

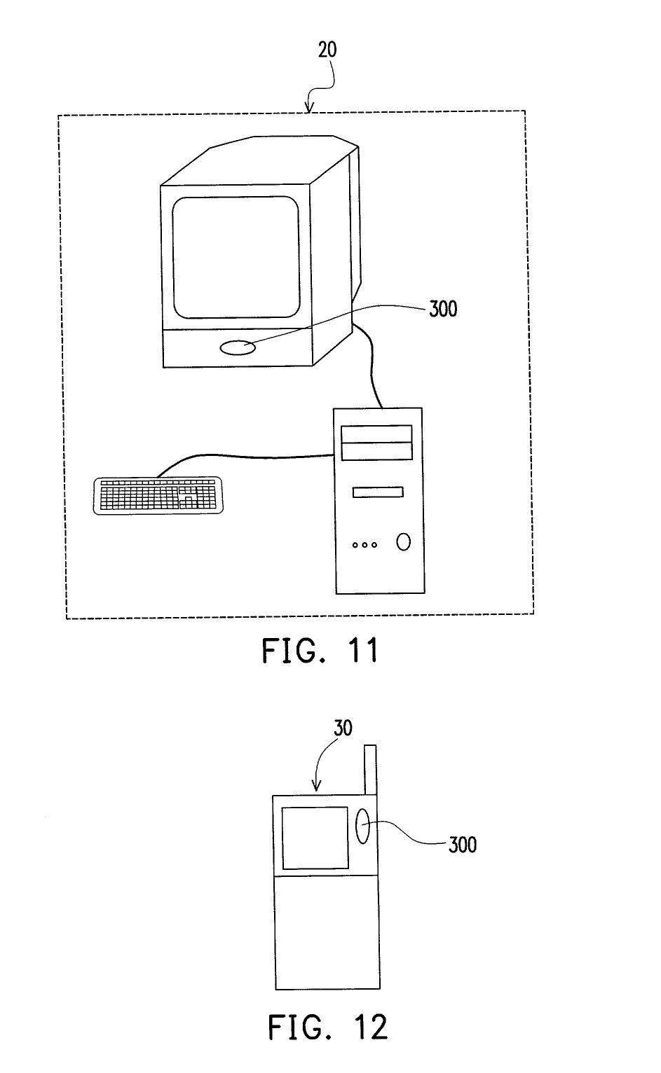

Referring to FIG. 11, is a schematic showing a personal computer 20 in accordance with a preferred embodiment of the present invention. The personal device 20 comprises at least a camera device (not shown), a scanning window 300 for scanning fingerprint image and means of converting said fingerprint image into a fingerprint digital identifier data. The personal computer 20 comprises means of verifying said fingerprint identifier data and means for allowing or denying access to secured sites according to the result of the verification of said fingerprint identifier data.

Referring to FIG. 12, is a schematic front view showing a cellular phone 30, in accordance with a preferred embodiment of the present invention. The cellular phone 30 comprises at least a camera device (not shown), a scanning window 300 for scanning fingerprint image and means of converting said fingerprint image into a fingerprint digital identifier data. The cellular phone 30 comprises means of verifying said fingerprint identifier data and means for allowing or denying access to secured sites according to the result of the verification of said fingerprint identifier data.

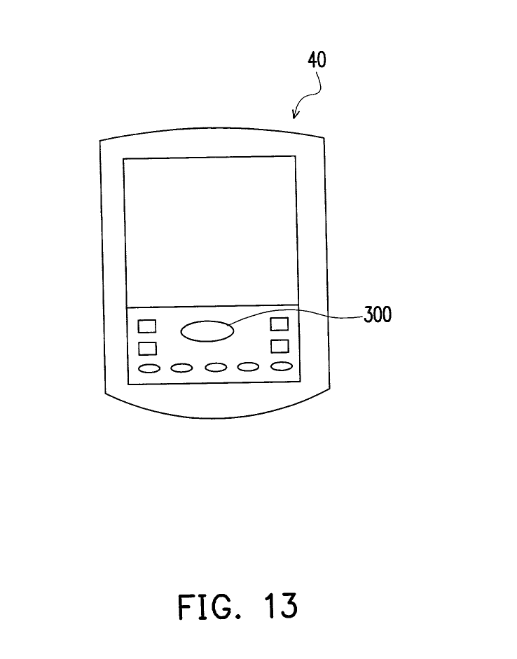

Referring to FIG. 13, is a schematic front view showing a PDA 40, in accordance with a preferred embodiment of the present invention. The PDA 40 comprises at least a camera device (not shown), a scanning window 300 for scanning fingerprint image and means of converting said fingerprint image into a fingerprint digital identifier data. The PDA 40 comprises means of verifying said fingerprint identifier data and means for allowing or denying access to secured sites according to the result of the verification of said fingerprint identifier data.

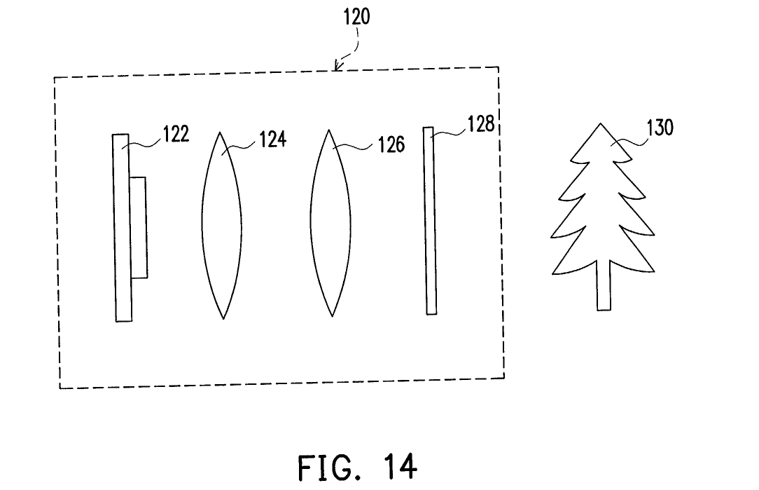

Referring to FIG. 14, is a schematic showing a camera device 120, in accordance with a preferred embodiment of the present invention. The camera device 120 comprises at least a sensor 122, a stationary lens 124 and a non-stationary lens 126, wherein the stationary lens 124 is disposed in between the sensor 122 and the non-stationary lens 126. The sensor 122 is preferably a CCD sensor. The non-stationary lens 126 can be moved with respect to the stationary lens 124 for adjusting the focal length in order to capture an acceptable to a high resolution image of an object 130 on a stationary screen 128, which image can be converted into a digital identifier data. The object 130 can be a stationary object or a moving object, and the distance of the object 130 with respect to sensor 122 can be variable.

Other objects and advantages of the present invention will become readily apparent to those skilled in this art from the above detailed description. Therefore, it is understood that the foregoing general description and the following detailed description are exemplary, but are not restrictive, of the present invention.

Those skilled in the art will appreciate many benefits and advantages afforded by the present invention. Of particular importance is the feature of taking into account the fingerprint images to provide an economical, faster, highly reliable and secure way of accessing to secured files. This feature raises the level of reliability for the security system to manage secret files.

While the invention has been particularly shown and described with reference to the preferred embodiments thereof, it will be understood by those skilled in the art that various changes in form and detail may be made therein without departing from the spirit and scope of the invention. Accordingly, it is intended to embrace all such alternatives, modifications, and variations which fall within the spirit and scope of the included claims. All matters set forth herein or shown in the accompanying drawings are to be interpreted in an illustrative and non-limiting sense.

What is claimed is:

1. An authentication system for verifying a fingerprint, said system comprising:
a network server; and
an artificial intelligent device coupled to said network server, comprising means of generating a fingerprint digital data of an applied fingerprint, wherein said network server comprises means for verifying said fingerprint digital data and accordingly generating a verification signal, and an access mechanism responsive to the verification signal for granting or denying access to a secured site according to the verification signal.

2. The authentication system according to claim 1, wherein the network server comprises:
a processor for generating a first fingerprint digital identifier data and a second fingerprint digital identifier data;
a fingerprint database memory for storing the first fingerprint digital identifier data; and
a comparator for comparing said first and second fingerprint digital identifier data.

3. The authentication system according to claim 1, wherein the artificial intelligent device coupled to the network server through a wired communication network system.

4. The authentication system according to claim 1, wherein the artificial intelligent device coupled to the network server through a wireless communication network system.

5. The authentication system according to claim 1, wherein said secured site comprises data files stored within the network server.

6. The authentication system according to claim 1, wherein said secured site comprises an internet-based management system.

7. The authentication system according to claim 1, wherein the artificial intelligent device comprises a computer camera.

8. The authentication system according to claim 1, wherein the artificial intelligent device comprises a scanner device.

9. The authentication system according to claim 1, wherein the artificial intelligent device comprises a projector device.

10. The authentication system according to claim 1, wherein the artificial intelligent device comprises a monitor.

11. An authentication system for verifying a fingerprint, said system comprising:
a cellular phone, comprising at least a scanner device for scanning an optical image, said cellular phone comprising means of generating a image digital data of an applied image, means for verifying said image digital data and accordingly generating a verification signal, and an access mechanism responsive to the verification signal.

12. The authentication system according to claim 11, wherein the optical image is a fingerprint image.

13. The authentication system according to claim 11, wherein the optical image is a still image.

14. An authentication system for verifying a fingerprint, said system comprising:
a PDA, comprising at least a scanner device for scanning an optical image, said PDA comprising means of generating a image digital data of an applied image, means for verifying said image digital data and accordingly generating a verification signal, and an access mechanism responsive to the verification signal.

15. The authentication system according to claim 14, wherein the optical image is a fingerprint image.

16. The authentication system according to claim 14, wherein the optical image is a still image.

17. A personal computer camera, comprising:
a housing comprising a camera window and a scanning window, wherein the camera window facing a horizontal plane and the scanning window facing a vertical plane;
an electronic camera disposed in said housing for converting an optical image into an electronic image, said electronic camera comprising at least a prism and a sensor, wherein said electronic camera is pivotally mounted to rotate along a horizontal axis for selecting to capture an optical image through the camera window or through the scanning window.

18. The personal computer camera according to claim 17, wherein the electronic image is transmitted to a personal computer.

19. The personal computer camera according to claim 18, wherein the personal computer comprises means of verifying said electronic image and means generating an access denied signal when said electronic image does not meet a preprogrammed criterion.

20. The personal computer camera according to claim 18, wherein the personal computer comprises means of verifying said electronic image and means generating an access signal when said electronic image meets a preprogrammed criterion.

21. The personal computer camera according to claim 18, wherein the personal computer comprises communication means for transmitting and/or receiving image information, said communication means capable of permitting information communication with one of a plurality of different external devices connected to this apparatus via predetermined connection means.

22. The personal computer camera according to claim 17, wherein the electronic image captured through the scanning window is a fingerprint image.

23. The personal computer camera according to claim 17, wherein the electronic image captured through the camera window is a fingerprint image.

24. The personal computer camera according to claim 17, wherein the electronic image captured through the camera window is a still image.

25. The personal computer camera according to claim 17, wherein the electronic image captured through the camera window is a motion image.

26. The personal computer camera according to claim 17, wherein the electronic image captured through the camera window is an animation image.

27. A camera device, comprising:
a sensor;
a stationary lens;
a non-stationary lens, wherein the stationary lens is disposed in between the sensor and the non-stationary lens; and
a stationary screen for displaying an image of an object, wherein the screen is disposed in between the non-stationary lens and the object and wherein the non-stationary lens is movable with respect to the stationary lens for adjusting the focal length in order to capture an image with an acceptable level of resolution.

28. The camera device according to claim 27, wherein the image is a fingerprint image.

29. The camera device according to claim 27, wherein the image is a still image.

30. The camera device according to claim 27, wherein the image is a motion image.

31. The camera device according to claim 17, wherein the image is an animation image.
